(19) United States
(12) Patent Application Publication
(10) Pub. No.: US 2006/0263645 A1
(43) Pub. Date: Nov. 23, 2006

(54) Substrate for perpendicular magnetic recording medium and method for production thereof

(76) Inventor: Masahiro Ohmori, Tochigi (JP)

Correspondence Address: SUGHRUE MION, PLLC, 2100 PENNSYLVANIA AVENUE, N.W., SUITE 800, WASHINGTON, DC, 20037, US

(21) Appl. No.: 10/553,395

(22) PCT Filed: Apr. 21, 2004
(86) PCT No.: PCT/JP04/05678

§ 371 Date: Jul. 10, 2006

Related U.S. Application Data
(60) Provisional application No. 60/465,223, filed on Apr. 25, 2003.

(30) Foreign Application Priority Data
Apr. 21, 2003 (JP) 2003-116290

(51) Int. Cl. G11B 5/706; G11B 5/66

(52) U.S. Cl. 428/846.2; 428/846.6; 428/832; 205/255; 205/259; 451/36

(57) ABSTRACT

A substrate for use in a perpendicular magnetic recording medium includes a blank substrate and a film of phosphorus- or boron-containing cobalt alloy formed on the blank substrate by electroless plating, the electroless plated film of the cobalt alloy having surface roughness Ra in the range of 0.05 nm to 1 nm. A method for the production of a substrate for use in a perpendicular magnetic recording medium includes a step of forming on a blank substrate a film of phosphorus-containing cobalt alloy by electroless plating and a step of polishing a surface resulting from the step of forming the film by the plating.

### CROSS REFERENCE TO RELATED APPLICATIONS

This application is an application filed under 35 U.S.C. §111 (a) claiming the benefit pursuant to 35 U.S.C. §119(e)(1) of the filing date of Provisional Application No. 60/465,223 filed Apr. 25, 2003 pursuant to 35 U.S.C. §111(b).

### TECHNICAL FIELD

This invention relates to a substrate for a perpendicular magnetic recording medium to be used for what is called a hard disk and a method for the production thereof

### BACKGROUND ART

As an external memory device for the electronic information apparatuses represented by computers, a fixed type magnetic recording device (magnetic disk drive) popularly called a hard disk is used. Generally, as the recording medium (magnetic recording medium) for this fixed type magnetic recording device, the blank substrate of aluminum, glass or silicon is used. This blank substrate is produced, when necessary, with various films sequentially formed thereon. In the case of the magnetic recording medium which uses an aluminum substrate, it is generally produced by having a nonmagnetic metal primary coat, a magnetic film, a protective film and a lubricating film sequentially formed on an aluminum blank which has undergone the steps of smoothing by grinding, surface cleaning, treatment for displacement of zinc, formation of electroless Ni—P alloy film and surface polishing.

With reference to the case of the aluminum substrate, the expression “substrate for the magnetic recording medium” refers to a substrate which results from forming an Ni—P alloy film on the smoothened blank substrate of aluminum, subjecting the resultant coated substrate to the step of surface polishing and smoothing the surface (refer to JP-A 2001-209925, for example).

In recent years, the trend of the electronic information apparatuses toward the enhancement of performance has been posing the improvement of recording density as a pressing need to the apparatus manufacturing industry. Even the hard disks form no exception to this sway of situation. As a way of solving this task, the feasibility of altering the method of recording has been being studied. The efforts are directed at changing the existing method of in-plane recording to the method of perpendicular recording.

Several methods have been proposed for the prospective perpendicular magnetic recording. Among such proposals, the superposed medium that is formed by attaching a soft magnetic film possessing a high, saturated magnetic flux density to the lower side of a perpendicular magnetic recording layer and the method that uses a single magnetic pole head are now rated high. In the case of the substrate of aluminum blank for use in the perpendicular magnetic recording medium, the substrate of a configuration having a soft magnetic film formed next a Ni—P alloy film is used.

The soft magnetic film is preferred to possess a high magnetic permeability and a high, saturated magnetic flux density. The technique for forming the soft magnetic film by depositing a NiFe layer according to the principle of sputtering has been disclosed (refer to JP-C 2911050, for example).

Incidentally, attempts are also being made to form the soft magnetic layer by the plating method (electrolytic plating or electroless plating) that is less expensive than the sputtering method. The plating method, notwithstanding the film produced by the plating method has poor surface smoothness as compared with the film produced by the sputtering method and necessitates a polishing step, confronts the situation that the optimum polishing method remains yet to be established (refer to JP-A HEI 10-158869, for example).

Further, since the perpendicular magnetic recording method still suffers the head to reveal a small ascending value (glide height), the substrate for use in the magnetic recording medium has been requested to possess such surface smoothness as has never been attained to date.

This invention has been initiated in view of the true state of affairs mentioned above and has for the object thereof the provision of a substrate for the perpendicular magnetic recording medium which enjoys a highly smoothed surface in spite of adopting the plating method and permits addition to recording density and a method for the production thereof To accomplish the object mentioned above, this invention has adopted the following items for the construction.

### DISCLOSURE OF THE INVENTION

The present invention provides a substrate for use in a perpendicular magnetic recording medium, comprising a blank substrate and a film of phosphorus- or boron-containing cobalt alloy formed on the blank substrate by electroless plating, the electroless plated film of the cobalt alloy having surface roughness Ra in the range of 0.05 nm to 1 nm.

In the substrate for use in a perpendicular magnetic recording medium, a number of defects occurring on a surface of the electroless plated film of the cobalt alloy and measuring 0.1 μm or more in diameter and 7 nm or more in depth is less than 5 per surface.

In the first mentioned substrate for use in a perpendicular magnetic recording medium, wherein a number of projections occurring on the surface of the electroless plated film of the cobalt alloy and measuring 0.1 μm or more in diameter and 7 nm or more in height is less than 5 per surface.

In any one of the substrates for use in a perpendicular magnetic recording medium, the electroless plated film of the cobalt alloy has a phosphorus content in the range of 1 mass % to 30 mass %.

In any one of the substrates for use in a perpendicular magnetic recording medium, the electroless plated film of the cobalt alloy has a boron content in the range of 0.1 mass % to 10 mass %.

In any one of the substrates for use in a perpendicular magnetic recording medium, the electroless plated film of the cobalt alloy has a thickness in the range of 0.1 μm to 5 μm.

The invention further provides a method for the production of a substrate for use in a perpendicular magnetic recording medium, comprising a step of forming on a blank substrate a film of phosphorus- or boron-containing cobalt alloy by electroless plating and a step of polishing a surface resulting from the step of forming the film by the plating.

In the method for the production of a substrate for use in a perpendicular magnetic recording medium, the polishing step removes the electroless plated film of the cobalt alloy in a depth in the range of 0.15 μm to 10 μm and thins the electroless plated film of the cobalt alloy to a thickness in the range of 0.1 μm to 5 μm.

In any one of the methods mentioned above for the production of a substrate for use in a perpendicular magnetic recording medium, the polishing step uses polishing liquid containing water and abrasive grains and further contains at least one member selected from the group consisting of an oxidizing agent, a chelating agent and a pH-adjusting agent In the method just mentioned above for the production of a substrate for use in a perpendicular magnetic recording medium, the polishing liquid has a pH value in the range of 3 to 9.5.

In any one of the third and fourth mentioned methods for the production of a substrate for use in a perpendicular magnetic recording medium, the abrasive grains contained in the polishing liquid have a concentration in the range of 1 mass % to 30 mass %.

In any one of the methods mentioned above for the production of a substrate for use in a perpendicular magnetic recording medium, the abrasive grains contained in the polishing liquid are SiO₂ grains having an average particle diameter (D50) of 20 nm or less.

In any one of the methods mentioned above for the production of a substrate for use in a perpendicular magnetic recording medium, the oxidizing agent contained in the polishing liquid is hydrogen peroxide.

In any one of the methods mentioned above for the production of a substrate for use in a perpendicular magnetic recording medium, the chelating agent contained in the polishing liquid contains at least one compound selected from the group consisting of EDTA, citric acid and succinic acid.

In any one of the methods mentioned above for the production of a substrate for use in a perpendicular magnetic recording medium, the pH-adjusting agent contained in the polishing liquid contains at least one member selected from the group consisting of aqueous ammonia, water-soluble organic acid and salts thereof

It is assumed that why the surface of the plated film produced by the aforementioned plating method is flattened and smoothed to a high level owing to the selection of a pH-adjusting agent optimum for the cobalt alloy that would prevent formation of polishing pits.

### BRIEF DESCRIPTION OF THE DRAWING

FIG. 1 is a cross section showing one embodiment of the substrate according to the present invention for a perpendicular magnetic recording medium.

### BEST MODE FOR CARRYING OUT THE INVENTION

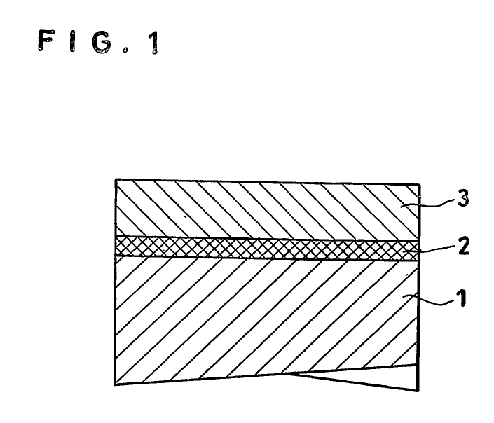

A substrate of the present invention for use in a magnetic recording medium comprises a substrate material 1 and an electroless plated film 3 of phosphorus- or boron-containing cobalt alloy formed on the substrate material 1, as shown in FIG. 1.

As the raw materials for a substrate that can be used in this invention, aluminum, glass, silicon, etc. are preferred examples, though other materials do not need to be particularly restricted. For the sake of forming an electroless-plated film 3 of the phosphorus- or boron-containing cobalt alloy, however, the blank substrates 1 of all kinds are invariably required to undergo a treatment to coat the blank substrate 1 with a prime coat 2. When the material is aluminum, for example, it requires a treatment for the displacement of zinc. When the material is glass, it requires a Pd/Sn treatment The electroless-plated film 3 of the phosphorus- or boron-containing cobalt alloy to be used in this invention is preferred to be peculiar in lacking a magnetic wall unlike the ordinary plated film. Generally, a thin film manifesting a magnetic property unexceptionally possesses a magnetic wall. This invention derives particularly advantageous characteristic properties from using a thin film showing no discernible magnetic wall.

For this purpose, the film is preferred to rely on the electroless plating method to contain phosphorus therein. The reason for this discrimination is that the film of phosphorus- or boron-containing cobalt alloy, when formed by the electroless plating method, enjoys such fine division of particles as induces disappearance of a magnetic wall. Incidentally, the electrolytic plating method attains such inclusion of phosphorus only with difficulty. The sputtering method encounters the same difficulty. The electroless plated film of the phosphorus-containing cobalt alloy is required to possess a high, saturated magnetic flux density. The saturated magnetic flux density preferably falls in the range of 0.5 T to 2 T. In order for the film to acquire this saturated magnetic flux density, it is preferred to contain a magnetic metal other than cobalt. As concrete examples of the metal that can be used for this addition, Fe, Ni, Cr, Mn and Zn may be cited. The content of this metal is preferred to be 20 mass % at most.

The Ra of the substrate for the perpendicular magnetic recording medium contemplated by this invention is preferred to be 0.05 nm or more and 1 nm or less. More preferably, it is 0.5 nm or less. If the Ra exceeds 1 nm, the excess will be at a disadvantage in inducing an increase of the Ra of the magnetic recording layer to be formed at the step of producing the perpendicular magnetic recording medium and compelling the recording head during the course of the actual magnetic recording to produce an unstable run.

The number of defects or projections which occur in the electroless plated film of the phosphorus- or boron-containing cobalt alloy contemplated by this invention and measure 0.1 μm or more in diameter and 7 nm or more in depth or height is preferred to be less than 5 per a piece (one surface) of the substrate for the perpendicular magnetic recording medium. More preferably, this number is 3 or less. If this number exceeds 5, the excess will be at a disadvantage in inflicting missing parts to the recording regions corresponding to the sites of defects and degrading the recording capacity per substrate. When the defects are projections, so many projections do not deserve welcome because they have the possibility of bringing the head to crush to wholly destroy the device.

The electroless plated film of the phosphorus- or boron-containing cobalt alloy contemplated by this invention is preferred to have a thickness of 0.1 μm or more and 5 μm or less. If this thickness falls short of 0.1 μm, the shortage will be at a disadvantage in preventing the film from functioning as a soft magnetic layer during the course of actual recording and consequently allowing no writing. If the thickness exceeds 5 μm, the excess will prevent the characteristic properties from enjoying a generous change and consequently prove wasteful economically. The amount of abrasion of the phosphorus-containing cobalt alloy is preferred to be 0.15 μm or more and 10 μm or less. If the amount of abrasion falls short of 0.15 μm, the shortage will obstruct the acquisition of expected surface smoothness and prevent the film from being used as the substrate for the perpendicular magnetic recording medium. If this amount exceeds 10 μm, the excess will result in increasing the waste of the expensive cobalt alloy film from the economic point of view.

The phosphorus content in the electroless plated film of the phosphorus- or boron-containing cobalt alloy contemplated by this invention is preferred to be 3 mass % or more and 15 mass % or less. More preferably, it is 5 mass % or more and 10 mass % or less. If the phosphorus content exceeds 15 mass %, the excess will result in lowering the saturated magnetic flux density of the film and degrading the ability of the film to function as a soft magnetic layer and preventing the film from allowing expected writing during the course of recording. Conversely, if the phosphorus content falls short of 3 mass %, the shortage will be at a disadvantage in degrading the corrosiveness of the film and suffering the film to succumb to oxidation easily. The boron content is preferred to be 0.1 mass % or more and 7 mass % or less and further preferred to be 1 mass % or more and 7 mass % or less, for the same reasons as in the case of the phosphorus.

The polishing liquid that can be used in this invention has a pH value of 3 or more 9.5 or less. If this pH value falls short of 3 or exceeds 9.5, the deviation will be at a disadvantage in suffering the electroless plated film of the phosphorus- or boron-containing cobalt alloy to succumb to complete chemical solution quickly. As the material for the abrasive grains contained in the polishing liquid, alumina and colloidal silica are preferably used and silica is particularly preferably used. The concentration of the abrasive grains in the polishing liquid is preferred to be 1 mass % or more and 30 mass % or less. If this concentration fills short of I mass %, the shortage will be at a disadvantage in preventing the abrasion from being effected sufficiently. Conversely, if the concentration exceeds 30 mass %, the excess will be at a disadvantage in degrading the ability of the polishing liquid to expel the part of the film loosed by abrasion.

Further, the polishing liquid is preferred to incorporate therein various additives. The additives include oxidizing agents, chelating agents, surfactants, organic solvents and pH-adjusting agents, for example. Preferably, hydrogen peroxide is used as an oxidizing agent; EDTA, citric acid or succinic acid is used as a chelating agent; cationic surfactants like dodecyl quatemary ammonium salt, nonionic surfactants like polyoxyethylene lauryl amine, and amphoteric surfactants like alkyl glycines are used as surfactants; alcohols like methanol, and ethers like ethylene glycol monoethyl ether are used as organic solvents; and organic acids like citric acid, ammonia, and salts thereof are used as pH-adjusting agents. It is preferred that the amounts of these additives to be added are optimized to suit the condition of polishing.

Now, this invention will be more specifically described below with reference to Examples. This invention is not limited to the following Examples.

Electroless Plating of Phosphorus-Containing Cobalt Alloy:

A 2.5 inch-diameter substrate resulting from plating aluminum with Ni—P was subjected to acid washing, water-washing treatment and electroless plating of a phosphorus-containing cobalt alloy. The composition of the plating liquid and the condition of the plating that were used in this case were as shown in Table 1-I. The phosphorus concentration in the electroless plated film of the phosphoms-containing cobalt alloy was found by the analysis of the film to be 7 mass %. The thickness of the electroless plated film of the phosphorus-containing cobalt alloy was set at 1.5 μm.

Electroless Plating of Boron-Containing Cobalt Alloy:

A 2.5 inch-diameter substrate resulting from plating aluminum with Ni—P was subjected to acid washing, water-washing treatment and electroless plating of a boron-containing cobalt alloy. The composition of the plating liquid and the condition of the plating that were used in this case were as shown in Table 1-II. The boron concentration in the electroless plated film of the boron-containing cobalt alloy was found by the analysis of the film to be 3 mass %. The thickness of the electroless plated film of the boron-containing cobalt alloy was set at 1.5 μm.

TABLE 1-I
Composition of plating liquid

| | | |
|---|---|---|
| Hypophosphorous acid | 0.2 | mol/dm³ |
| C₃H₄(OH)(COONa)₃ | 0.1 | mol/dm³ |
| C₂H₂(OH)₂(COONa)₂ | 0.15 | mol/dm³ |
| (NH₄)₂SO₄ | 0.5 | mol/dm³ |
| FeSO₄.7H₂O | 0.002 | mol/dm³ |
| NiSO₄.6H₂O | 0.01 | mol/dm³ |
| CoSO₄.7H₂O | 0.04 | mol/dm³ |
| Bath temperature (° C.) | 90 | |
| pH | 9 | (adjusted with NaOH) |

TABLE 1-II
Composition of plating liquid

| | | |
|---|---|---|
| Dimethylamineboran (DMAB) | 0.025 | mol/dm³ |
| C₃H₄(OH)(COONa)₃ | 0.05 | mol/dm³ |
| C₂H₂(OH)₂(COONa)₂ | 0.20 | mol/dm³ |
| H₃PO₄ | 0.06 | mol/dm³ |
| (NH₄)₂SO₄ | 0.005 | mol/dm³ |
| FeSO₄.7H₂O | 0.01 | mol/dm³ |
| NiSO₄.6H₂O | 0.005 | mol/dm³ |
| CoSO₄.7H₂O | 0.095 | mol/dm³ |
| Bath temperature (° C.) | 70 | |
| pH | 9 | (adjusted with NaOH) |

Then, the polishing liquid was prepared as follows.

Polishing Liquid:

The polishing liquids shown in Table 2 were prepared using colloidal silica (an average particle diameter (D50): 0.02 μm, made by Japan Aerosil Ltd.), a pH-adjusting agent, hydrogen peroxide and water. In this case, citric acid and ammonia were used for the adjustment of pH. Incidentally, the concentration of hydrogen peroxide was set at 100 g/l.

### EXAMPLES 1 to 3

The 2.5 inch-diameter aluminum substrate having an electroless plated film of phosphorus-containing cobalt alloy formed thereon was subjected to a polishing test performed under the following conditions and using a supernatant resulting from lightly stirring various polishing liquids shown in Table 2.

### EXAMPLES 4 and 5

The 2.5 inch-diameter aluminum substrate having an electroless plated film of boron-containing cobalt alloy formed thereon was subjected to a polishing test performed under the following conditions and using a supernatant resulting from lightly stirring various polishing liquids shown in Table 2.

TABLE 2

| Concentration of abrasive | | | |
|---|---|---|---|
| grains in polishing liquid | | pH | Experiment |
| 10 | mass % | 4.5 | Example 1 |
| 17 | mass % | 7.5 | Example 2 |
| 6 | mass % | 9.0 | Example 3 |
| 30 | mass % | 9.0 | Example 4 |
| 1 | mass % | 9.0 | Example 5 |
| 1 | mass % | 11.5 | Example 6 |
| 1 | mass % | 7.5 | Example 7 |
| 13 | mass % | 2.2 | Example 8 |

Polishing Conditions:

Substrate: Product obtained by forming an electroless plated film of phosphorus-or boron-containing cobalt alloy on an aluminum blank for a 2.5-inch hard disk; Polishing machine: Double-face polishing machine (50 disks/batch); Pad: Polyurethane-based pad; Polishing time: 5 minutes; Surface pressure during the course of polishing: 50 g/cm²; Amount of polishing liquid supplied: 30 ml/minute.

Method of Evaluation:

The surface roughness Ra was measured by the use of a surface roughness tester made by Vecco Corp. and sold under the trademark designation of “TMS2000.” The defects or the projections on the surface were determined with a disk surface defect-testing device made by Hitachi Engineering K.K. and sold under the trademark designation of “RS-1350.” The results are shown in Table 3. The measured values of surface roughness and defects and projections shown in the table were averages of the numerical values obtained on 10 different substrates polished under the same conditions.

The S/N ratio is obtained as an MF-S/N ratio through measurement of the electromagnetic conversion feature of a magnetic recording medium having a 5 nm-thick C film formed as a protective layer on a formed perpendicular magnetic recording layer using a complex head comprising a single magnetic pole head as a writing portion and a shield magnetic resistance head as a reading portion.

TABLE 3

| | Amount | Surface | Number of defects | S/N |
|---|---|---|---|---|
| | abraded | roughness | and projections | ratio |
| | (μm) | (nm) | (counts/surface) | (dB) |
| Example 1 | 0.80 | 0.22 | 1.8 | 14.5 |
| Example 2 | 0.20 | 0.57 | 3.8 | 13.8 |
| Example 3 | 0.60 | 0.13 | 2.7 | 15.7 |
| Example 4 | 0.60 | 0.01 | 4.8 | 16.0 |
| Example 5 | 0.20 | 1.00 | 5.0 | 13.6 |
| Example 6 | 1.5 or more | 2.01 | 400 | 4.4 |
| Example 7 | 0.05 | 1.68 | 300 | 8.4 |
| Example 8 | 1.5 or more | 3.11 | 450 | 3.1 |

It is clear from Table 3 that Examples 1 to 5 excelled Examples 6 to 8 in terms of surface smoothness of the plated films (surface roughness and numbers of pots and projections), resulting in a high S/N ratio to provide an excellent recording medium. Incidentally, in Examples 6 and 8, the measurements, the features are considerably lowered because the polishing liquids completely dissolved the plated films of phosphorus-containing cobalt alloy.

### INDUSTRIAL APPLICABILITY

By this invention, it is made possible to provide a substrate for a perpendicular magnetic recording medium provided with an electroless plated film of phosphorus- or boron-containing cobalt alloy which is devoid of defect and projection and rich in surface smoothness and, consequently, permit manufacture of a magnetic recording medium enjoying a high recording density.

1. A substrate for use in a perpendicular magnetic recording medium, comprising a blank substrate and a film of phosphorus- or boron-containing cobalt alloy formed on the blank substrate by electroless plating, the electroless plated film of the cobalt alloy having surface roughness Ra in the range of 0.05 nm to 1 nm.

2. The substrate for use in a perpendicular magnetic recording medium according to claim 1, wherein a number of defects occurring on a surface of the electroless plated film of the cobalt alloy and measuring 0.1 μm or more in diameter and 7 nm or more in depth is less than 5 per surface.

3. The substrate for use in a perpendicular magnetic recording medium according to claim 1, wherein a number of projections occurring on the surface of the electroless plated film of the cobalt alloy and measuring 0.1 μm or more in diameter and 7 μm or more in height is less than 5 per surface.

4. The substrate for use in a perpendicular magnetic recording medium according to any one of claims 1 to 3, wherein the electroless plated film of the cobalt alloy has a phosphorus content in the range of 1 mass % to 30 mass %.

5. The substrate for use in a perpendicular magnetic recording medium according to any one of claims 1 to 3, wherein the electroless plated film of the cobalt alloy has a boron content in the range of 0.1 mass % to 10 mass %.

6. The substrate for use in a perpendicular magnetic recording medium according to any one of claims 1 to 5, wherein the electroless plated film of the cobalt alloy has a thickness in the range of 0.1 μm to 5 μm.

7. A method for the production of a substrate for use in a perpendicular magnetic recording medium, comprising a step of forming on a blank substrate a film of phosphorus- or boron-containing cobalt alloy by electroless plating and a step of polishing a surface resulting from the step of forming the film by the plating.

8. The method for the production of a substrate for use in a perpendicular magnetic recording medium according to claim 7, wherein the polishing step removes the electroless plated film of the cobalt alloy in a depth in the range of 0.15 μm to 10 μm and thins the electroless plated film of the cobalt alloy to a thickness in the range of 0.1 μm to 5 μm.

9. The method for the production of a substrate for use in a perpendicular magnetic recording medium according to claim 7 or 8, wherein the polishing step uses polishing liquid containing water and abrasive grains and further contains at least one member selected from the group consisting of an oxidizing agent, a chelating agent and a pH-adjusting agent.

10. The method for the production of a substrate for use in a perpendicular magnetic recording medium according to claim 9, wherein the polishing liquid has a pH value in the range of 3 to 9.5.

11. The method for the production of a substrate for use in a perpendicular magnetic recording medium according to claim 9 or 10, wherein the abrasive grains contained in the polishing liquid have a concentration in the range of 1 mass % to 30 mass %.

12. The method for the production of a substrate for use in a perpendicular magnetic recording medium according to any one of claims 9 to 11, wherein the abrasive grains contained in the polishing liquid are SiO₂ grains having an average particle diameter (D50) of 20 nm or less.

13. The method for the production of a substrate for use in a perpendicular magnetic recording medium according to any one of claims 9 to 12, wherein the oxidizing agent contained in the polishing liquid is hydrogen peroxide.

14. The method for the production of a substrate for use in a perpendicular magnetic recording medium according to any one of claims 9 to 13, wherein the chelating agent contained in the polishing liquid contains at least one compound selected from the group consisting of EDTA, citric acid and succinic acid.

15. The method for the production of a substrate for use in a perpendicular magnetic recording medium according to any one of claims 9 to 14, wherein the pH-adjusting agent contained in the polishing liquid contains at least one member selected from the group consisting of aqueous ammonia, water-soluble organic acid and salt thereof.
